(19) United States
(12) Patent Application Publication
(10) Pub. No.: US 2005/0151367 A1
(43) Pub. Date: Jul. 14, 2005

(54) Fastener for a display page

(76) Inventors: Joy A. Packard, Somerset, WI (US); Gerald E. Mueller, Eagan, MN (US); Scott D. Pearson, Woodbury, MN (US)

Correspondence Address: 3M INNOVATIVE PROPERTIES COMPANY, PO BOX 33427, ST. PAUL, MN, 55133-3427, US

(21) Appl. No.: 11/011,738

(22) Filed: Dec. 14, 2004

Related U.S. Application Data
(60) Provisional application No. 60/530,592, filed on Dec. 18, 2003.

(51) Int. Cl. B42D 1/00

(52) U.S. Cl. 281/21.1

(57) ABSTRACT

A device for securing an article to a substrate, such as a display page, includes an elongated portion having a first end and a second end. A first end portion is coupled to the first end of the elongated portion. The device also includes a second end portion having a first major surface that is coupled to the second end of the elongated portion and a second major surface that is adapted for fastening to the substrate. When the fastener is attached to the article and secured to the substrate, the elongated portion passes through the article such that the article is positioned between the first end portion and the second end portion.

### CROSS-REFERENCE TO RELATED APPLICATION(S)

This application claims priority from U.S. Patent Application Ser. No. 60/530,592, filed Dec. 18, 2003, for “SCRAPBOOK ARTICLES” by Joy A. Packard, Scott D. Pearson, Gerald E. Mueller, and Gary A. Albrecht, which is herein incorporated by reference in its entirety.

### BACKGROUND OF THE INVENTION

The present invention relates to fasteners. More particularly, the present invention relates to fasteners for use with display pages.

Most generally, display pages are used with a book, album, binder or other holder that allows a user to store, organize and preserve scrapbook articles such as photographs, newspaper clippings, decorative papers, certificates, medals and other mementoes and memorabilia.

A scrapbook is a collection of one or more pages (e.g., display pages or scrapbook pages), each of which usually contains at least one photograph, writing, decorative element, memorabilia or the like. Most often, pages in the scrapbook are grouped by a common theme, such as a family vacation, wherein photographs and page embellishments are creatively and aesthetically arranged to preserve memories (reflected in the photographs) and enhance preserving and sharing those memories with other persons. Often, a user making the scrapbook desires to create a family heirloom that will last for generations.

A user (or “scrapbooker”) typically attaches articles to a scrapbook page using a variety of specialized tapes, glues and adhesives. This can be a very time consuming process while waiting for glues and adhesives to dry or cure sufficiently. For example, photographs and decorative papers are often attached with pressure sensitive adhesives or glue sticks. Non-cellulose embellishment articles such as ribbon, raffia and wire are typically much more difficult to place and challenging to attach, and such methods as hot melt adhesives or vinyl acetate glues are used, although with limited success. Because these methods involve a direct adhesive or glue attachment between the embellishment articles and the scrapbook page, the scrapbooker is often concerned with long-term preservation of the articles due to deterioration caused by the adhesive or glue. It is often undesirable to have any contact (or a substantial risk of contact) between the adhesive or glue and the scrapbook and embellishment articles. Furthermore, it is often desirable to remove a memorabilia item, such as a medal, during sharing of the scrapbook, and then return it to the scrapbook page. The adhesive or glue methods generally do not accomplish this well.

Occasionally, a scrapbooker will utilize items such as brads and nail heads that are affixed to a scrapbook page by methods such as puncturing the scrapbook page and bending or deforming a portion of the fastener (typically deforming a portion of the fastener that protrudes through the scrapbook page), which secures them to the scrapbook page. This method is often undesirable because it requires tearing or perforation of the scrapbook page, which can, in turn, lead to damage of articles stored on the scrapbook page. In addition, this method can leave sharp points exposed, which can damage adjacent scrapbook pages (and the articles stored on those adjacent pages).

Items used to affix scrapbook and embellishment articles can have sharp points, corners and otherwise have non-smooth and non-rounded features. Because a typical scrapbook includes a number of display pages positioned adjacent each other like a book, contact between the non-smooth and non-rounded items and other objects can cause damage to, for example, adjacent display pages and display and embellishment articles affixed thereon.

Another problem faced by a scrapbooker is the time required to assemble, affix, arrange, decorate and organize a display page for a scrapbook. It is undesirable to spend considerable time gluing, knotting, wrapping and performing other attachment operations to secure display and embellishment articles on a display page. Such attachment operations can be undesirably complicated.

Therefore, there is a need to for an improved way of securely, conveniently, quickly and creatively providing means to attach the items and elements of a scrapbook to the page that does not detract from the aesthetic appearance of the scrapbook article. It is also desired to enhance the ability to easily remove and return items to a scrapbook page. It is still further desired to provide a fastener that contributes to the preservation of items on a scrapbook page and the scrapbook itself.

Thus, the present invention relates to fasteners that provide an alternative means of securing articles on a display page in a scrapbook or in other locations.

### BRIEF SUMMARY OF THE INVENTION

The present invention is a device for securing an article to a substrate, such as a display page. The device includes an elongated portion having a first end and a second end. A first end portion is coupled to the first end of the elongated portion. The device also includes a second end portion having a first major surface that is coupled to the second end of the elongated portion and a second major surface that is adapted for fastening to the substrate. When the fastener is attached to the article and secured to the substrate, the elongated portion passes through the article such that the article is positioned between the first end portion and the second end portion.

In one embodiment, at least a portion of the second major surface includes a layer of adhesive material, such as an acid-free adhesive, repositionable pressure sensitive adhesive, or permanent adhesive. A release liner is also removably provided on the adhesive material.

### BRIEF DESCRIPTION OF THE DRAWINGS

FIG. 1A is a perspective view of a fastener for securing articles on a display page according to an embodiment of the present invention.

FIG. 1B is a sectional view of the fastener shown in FIG. 1A.

FIG. 2 is a perspective view showing one means for attaching fasteners according to the present invention to an article to be secured to a display page.

FIG. 3 is a perspective view of an article attached to two fasteners according to the present invention and secured to a display page.

FIG. 4 is a sectional view of a fastener according to the present invention secured to a display page and showing fastener deformation that occurs when the scrapbook is closed.

While the above-identified drawing figures set forth one embodiment of the invention, other embodiments are also contemplated, as noted in the discussion. In all cases, this disclosure presents the invention by way of representation and not limitation. It should be understood that numerous other modifications and embodiments can be devised by those skilled in the art which fall within the scope and spirit of the principals of this invention. The figures may not be drawn to scale. Like reference numbers have been used throughout the figures to denote like parts.

### DETAILED DESCRIPTION

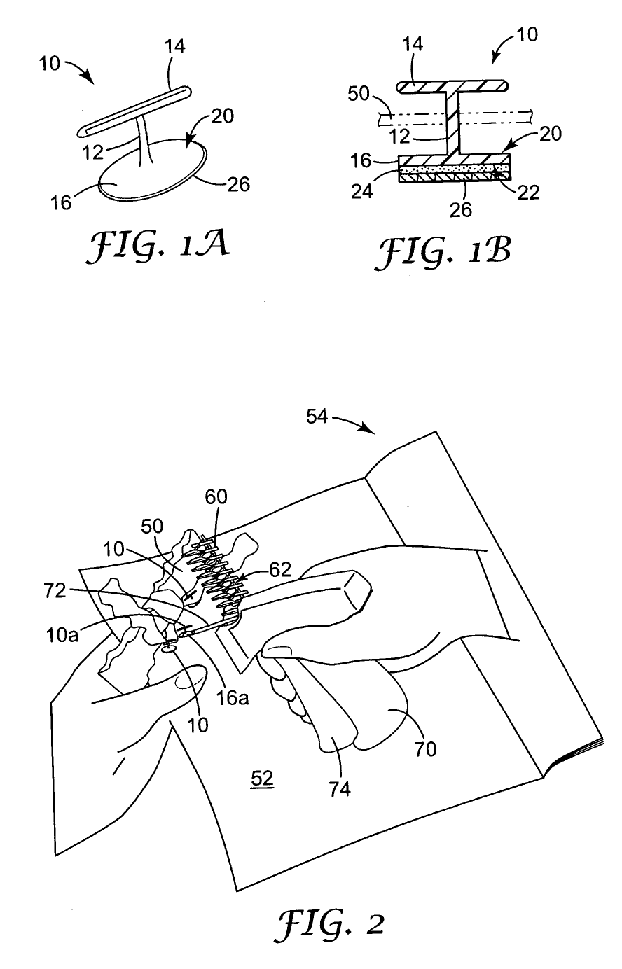

FIG. 1A is a perspective view and FIG. 1B is a cross-section view of fastener 10 for securing articles on a display page according to an embodiment of the present invention. Fastener 10 includes elongated connecting member 12, end bar 14, and base 16. Base 16 includes first surface 20 and second surface 22. Elongated member 12 is coupled to end bar 14 at one end and to first surface 20 at the other end. Base 16 also includes a layer of adhesive material 24 on second surface 22, and a release liner 26 is removably provided on adhesive material 24.

Fastener 10 is used to secure an article to a substrate, such as a display page in a scrapbook or album. The article to be secured to the display page is attached to fastener 10 by passing elongated member 12 through the article such that the article is affixed to fastener 10 and is positioned between end bar 14 and base 16. This prevents the article from moving relative to fastener 10.

Elongated member 12, end bar 14, and base 16 are preferably made of a resilient material that is pliable to facilitate easy attachment of fastener 10 to the article, but durable to endure handling and transporting of the substrate to which fastener 10 and the article held thereby are attached. In one embodiment, elongated member 12, end bar 14, and base 16 are made a polymeric material, such as nylon, polyurethane, polyethylene, polypropylene, a polyester, a polyamide, an ionomer, or the like. The polymeric material may be transparent such that fastener 10 does not obscure any portion of the article held thereby (or the display page to which fastener 10 is mounted). Alternatively, the polymeric material may be a colored or non-colored translucent or opaque material for ornamental purposes. Polymeric materials that are not appropriate for use in fastener 10 are those that include plasticizers, such as polyvinyl chloride, which may cause the integrity of fastener 10 to degrade over time and deleteriously affect the substrate or the article.

Elongated member 12, end bar 14, and base 16 are preferably formed integral with each other. In one embodiment, end bar 14 is transversely coupled to one end of elongated member 12 to form a substantial “T” shape. When an article is attached to fastener 10, elongated member 12 passes through a portion of the article and end bar 14 prevents the article from becoming disengaged from fastener 10 (embellishment article 50 is shown in phantom in FIG. 1B to illustrate this). While fastener 10 is shown including end bar 14 transversely coupled to one end of elongated member 12, end bar 14 may be replaced by any component that prevents the article from becoming disengaged from fastener 10.

Base 16 is coupled to the end of elongated member 12 opposite from end bar 14. Base 16 not only prevents the article attached to fastener 10 from becoming disengaged from fastener 10, but also provides the support for mounting the article to a display page. Particularly, base 16 includes second surface 22 that is adapted for fastening to the substrate. While second surface 22 is generally planar to provide a platform for adhesive layer 24, first surface 20 may also be generally planar as shown or may have an alternative configuration (e.g., hemispherical, cone-shaped, etc.). While base 16 is shown having a substantially elliptical shape, base 16 may have any size or shape which prevents the article attached to fastener 10 from becoming disengaged from fastener 10 and is capable of providing the support necessary for securing an article to a display page.

In one embodiment, second surface 22 includes a layer of adhesive material 24 to allow fastener 10, and the article supported thereby, to be mounted and displayed on any number of substrates, including albums and scrapbooks. Adhesive material 24 may be provided on a portion of second surface 22 or may completely coat second surface 22. Adhesive material 24 may be an acid-free, photograph-safe adhesive to prevent chemical damage to the substrate and any photographs that may be mounted near fastener 10. Adhesive material 24 may also be a repositionable adhesive, which permits fastener 10 to be adhered to and removed from a substrate multiple times without significant loss of adhesive capability. In one embodiment, the repositionable adhesive is a repositionable microsphere pressure sensitive adhesive, for example as described in U.S. Pat. Nos. 5,571,617, 5,045,569, 4,495,318, 4,166,152, 3,857,731, and 3,691,140. Additionally, adhesive material 24 may be a permanent adhesive.

In one embodiment, release liner 26 is provided on adhesive material 24 to prevent fastener 10 from becoming adhered to a surface before desired. When a user wishes to secure fastener 10 on a substrate, release liner 26 is peeled away from second surface 22 to expose adhesive material 24. When adhesive material 24 is exposed, fastener 10 may be mounted on a desired substrate. In one embodiment, release liner 26 is a sheet of paper coated with a release coating on its side facing adhesive material 24. The release coating may be of any known materials used for their release properties for adhesives. Exemplary materials of this type are silicones and modified silicones, the modification including both copolymerization of silicones with other non-release chemical agents or by adding non-silicone materials to the silicone coating solution prior to application to the base paper of the release liner. Other release agents such as polyethylene, fluorocarbons, and polyvinyl octadecyl carbamate may also be used. The choice of release coating is dependent on the tack, adhesion level, and chemical nature of adhesive material 24.

FIG. 2 is a perspective view of fasteners 10 according to the present invention attached to embellishment article 50 for securing to display page 52. Display page 52 is a page in scrapbook or album 54. Embellishment article 50 is attached to fastener 10 by passing elongated member 12 through the article such that the article is affixed to fastener 10 and is positioned between end bar 14 and base 16.

Fasteners 10 are manufactured and provided in the form of fastener stock 60. Fastener stock 60 includes a plurality of fasteners 10 arranged in a spaced, side-by-side orientation, with respective end bars 14 parallel to each other and respective bases 16 parallel to each other. End bars 14 are joined to a common member 62 by a severable connector. Fastener stock 60 is typically made through an injection molding process. Fasteners 10 are typically separated from common member 62, and subsequently attached to embellishment article 50, using a hand-held apparatus commonly referred to as a tagging gun Tagging gun 70 is shown in FIG. 2. An example of a tagging gun is disclosed in U.S. Pat. No. 4,955,475 entitled “Continuous Fastener Stock” by McCarthy et al., assigned to Dennison Manufacturing Company, which is hereby incorporated by reference.

Tagging gun 70 includes hollow needle 72 that is substantially cylindrical in shape and has a longitudinally extending bore (not shown) adapted to receive base 16 of fastener 10. Additionally, needle 72 includes a longitudinally extending slot (not shown) adapted to permit elongated member 12 and end bar 14 to extend therethrough while base 16 is disposed in the longitudinal bore of needle 72. Each base 16 of each fastener 10 in fastener stock 60 is aligned such that it sequentially fits through the longitudinal bore of needle 72. Fastener 10a is shown emerging from needle 72 of tagging gun 70 to show one such configuration, wherein base 16a of fastener 10a is deformed such that base 16a is capable of passing through the longitudinal bore of needle 72. When fastener 10a has been attached to article 50, base 16a is reformed such that second surface 22 is generally planar when secured to display page 52. Needle 72 also typically has a sharpened tip adapted for insertion into a desired article, such as embellishment article 50.

In use, fastener stock 60 is first loaded into tagging gun 70, as shown in FIG. 2. The sharpened tip of needle 72 is then inserted through the article to be mounted to display page 52, such as embellishment article 50. Trigger 74 on tagging gun 70 is then pulled by a user to force base 16 of the forwardmost fastener 10 of fastener stock 60 through needle 72 into embellishment article 50. When fastener 10 is attached to embellishment article 50, end bar 14 remains disposed on a side of embellishment article 50 opposite of base 16 (see FIG. 1B). As discussed above, elongated member 12 passes through a portion of embellishment article 50, and end bar 14 and base 16 are appropriately sized and shaped to prevent embellishment article 50 from becoming disengaged from fastener 10.

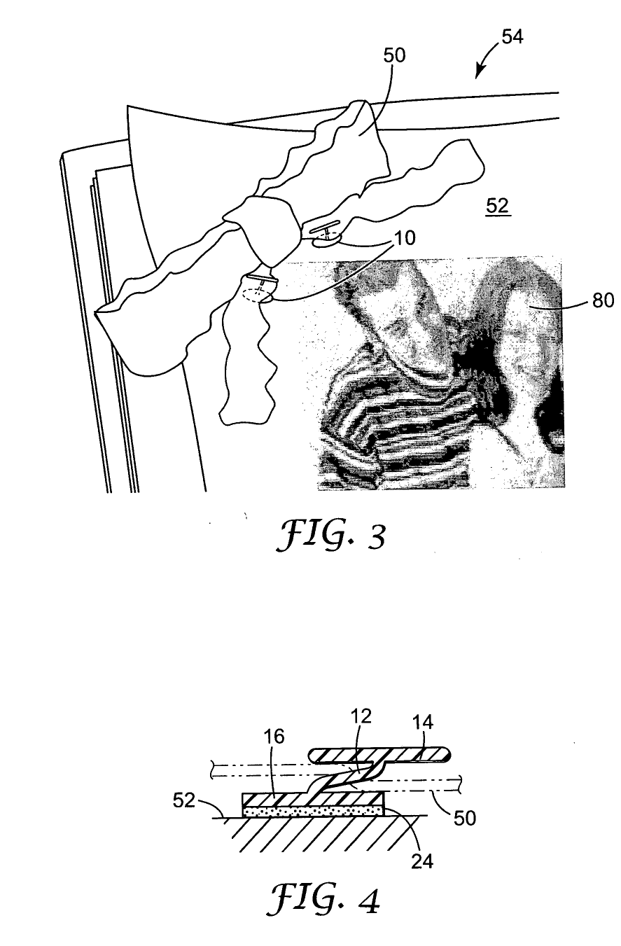

FIG. 3 is a perspective view of two fasteners 10 according to the present invention attached to embellishment article 50 and secured to the display page 52. When fasteners 10 have been attached to embellishment article 50, a user subsequently prepares fasteners 10 for securing to display page 52. In the embodiment of fastener 10 shown in FIGS. 1A and 1B, release liner 26 is first peeled from second surface 22 to expose adhesive material 24. When adhesive material 24 is exposed, fasteners 10 may be secured to display page 52. Fasteners 10 are then arranged and oriented on display page 52 as necessary to provide the desired positioning of embellishment article 50 relative to other articles on the page (e.g., photograph 80). Pressure is then applied to first surface 20 of each fastener 10 to secure fasteners 10 (and embellishment article 50 attached thereto) to display page 52.

When mounted on display page 52, a fastener 10 preferably has a minimal elevation relative to display page 52. In one embodiment, fastener 10 protrudes from display page 52 by less than 0.375 inch (0.953 cm). In addition, fastener 10 is typically made of a flexible material such that when scrapbook 54 is closed, elongated member 12 bends such that end bar 14 and portions of elongated member 12 lie substantially parallel to display page 52 (such as is shown in FIG. 4). This assures that fastener 10 does not increase the overall thickness profile of scrapbook 54 when it is closed, allowing for more attractive and efficient storage of scrapbook 54.

Fastener 10 of the present invention provides several advantages over the prior art. For example, unlike prior attachment methods that require direct contact between adhesive and the article to be secured to the substrate, no adhesive is provided on elongated member 12, end bar 14, or first surface 20 of base 16 (i.e., those element that come in contact with article 50). This prevents potentially deleterious contact between an adhesive material and embellishment article 50 or other articles on adjacent pages in scrapbook 54. Also, when provided with a repositionable adhesive fastener 10 may be readily detached and reattached to various substrates, allowing embellishment article 50 to be moved to various locations until placed in the desired position. In addition, fasteners 10 are easily removed from embellishment article 50, thereby allowing use of the article in another application without fasteners 10. Furthermore, two-sided memorabilia are mountable with a fastener 10 such that both sides of the memorabilia can be easily-viewed by pivoting the memorabilia on fastener 10.

Various modifications to fastener 10 and uses therefore that have been described may be made without departing from the spirit and scope of the present invention. For example, while embellishment article 50 is shown attached to display page 52 by fasteners 10 in FIGS. 2 and 3, it will be appreciated that a myriad of other articles may be secured to display page 52 using fasteners 10 according to the present invention. Other articles that may be attached using fasteners 10 include, but are not limited to, fabrics, plastics, ribbons, charms, medals, and certificates. Furthermore, fastener 10 has been described with regard to adhesive material 24 on second surface 22, but any material or mechanism may be used to provide a means for attaching fastener 10 to a substrate. Examples of alternative means for attaching fastener 10 to a substrate include surface fasteners such as hook and loop system fasteners, magnetic devices such as a magnetic strip or a magnetic backing, or other adhesive materials such as double-sided tape. Also, adhesive may be provided on the substrate to which the fastener is secured in addition to or instead of adhesive material 24 on second surface 22.

In summary, conventional items used to affix scrapbook and embellishment articles can have sharp points, corners and otherwise have non-smooth and non-rounded features. In addition, it is undesirable to spend considerable time gluing, knotting, wrapping and performing other attachment operations to secure display and embellishment articles on a display page. Furthermore, it is undesirable to have any contact (or a substantial risk of contact) between adhesive or glue on the securing device and the scrapbook and embellishment articles. The present invention relates to a fastener that addresses these and other issues by providing an alternative means of securing articles on a display page in a scrapbook or in other locations. The fastener includes an elongated portion having a first end and a second end. A first end portion is coupled to the first end of the elongated portion. The device also includes a second end portion having a first major surface that is coupled to the second end of the elongated portion and a second major surface that is adapted for fastening to the substrate. When the fastener is attached to the article, the elongated portion passes through the article such that the article is positioned between the first end portion and the second end portion. The fastener is compliant and resilient, has rounded edges and corners, and smooth surfaces in order to minimize possible damage to the article and underlying (or facing) display page.

Although the present invention has been described with reference to preferred embodiments, workers skilled in the art will recognize that changes may be made in form and detail without departing from the spirit and scope of the invention.

1. A device for securing an article to a substrate, the device comprising:
an elongated portion having a first end and a second end;
a first end portion coupled to the first end of the elongated portion; and
a second end portion having a first major surface coupled to the second end of the elongated portion and a second major surface adapted for fastening to the substrate,
wherein the elongated portion passes through the article such that the article is positioned between the first end portion and the second end portion when secured to the substrate.

2. The device of claim 1, wherein the first end portion comprises an end bar that is transversely coupled to the first end of the elongated portion.

3. The device of claim 1, wherein the elongated member, the first end portion, and the second end portion are integral.

4. The device of claim 1, wherein any of the elongated member, the first end portion, and the second end portion comprise a resilient material.

5. The device of claim 1, wherein the elongated member, the first end portion, and the second end portion comprise a polymeric material.

6. The device of claim 1, wherein at least a portion of the second major surface includes a layer of adhesive material.

7. The device of claim 6, wherein the adhesive material is an acid-free adhesive.

8. The device of claim 6, wherein the adhesive material is a repositionable pressure sensitive adhesive.

9. The device of claim 6, wherein the adhesive material is a permanent adhesive.

10. The device of claim 6, and further comprising:
a release liner removably provided on the adhesive material.

11. The device of claim 1, wherein the elongated portion is passed through the article with a tagging gun.

12. A fastener for securing an article to a display page, the device comprising:
an elongated member for passing through the article, the elongated member having a first end and a second end;
an end bar transversely coupled to the first end of the elongated member;
a base having a first side and a second side, wherein the second end of the elongated member is attached to the first side of the base; and
attaching means on the second side of the base for fastening the device to the display page.

13. The fastener of claim 12, wherein the elongated member, the end bar, and the base are integral.

14. The fastener of claim 12, wherein any of the elongated member, the end bar, and the base comprise a resilient material.

15. The fastener of claim 12, wherein the elongated member, the end bar, and the base comprise a polymeric material.

16. The fastener of claim 12, wherein the attaching means comprises an adhesive material.

17. The fastener of claim 16, wherein the adhesive material is an acid-free adhesive.

18. The fastener of claim 16, wherein the adhesive material is a repositionable pressure sensitive adhesive.

19. The fastener of claim 16, wherein the adhesive material is a permanent adhesive.

20. The fastener of claim 16, and further comprising:
a release liner removably provided on the adhesive material.

21. The fastener of claim 12, wherein the elongated member is passed through the article with a tagging gun.

22. A system for securing an article to a display page, the system comprising:
a fastener including an elongated member having a first end and a second end, an end bar transversely coupled to the first end of the elongated member, and a base having a first major surface coupled to the second end of the elongated member and a second major surface adapted for fastening to the substrate; and
a tagging gun for attaching the fastener to the article by passing the elongated member through the article such that the article is positioned between the end bar and the base when secured to the display page.

23. The system of claim 22, wherein at least a portion of the second major surface includes a layer of adhesive material.

24. The system of claim 23, wherein the adhesive material is an acid-free adhesive.

25. The system of claim 23, wherein the adhesive material is a repositionable pressure sensitive adhesive.

26. The system of claim 23, wherein the adhesive material is a permanent adhesive.

27. The system of claim 23, and further comprising:
a release liner removably provided on the adhesive material.
